(19) United States
(12) Patent Application Publication
(10) Pub. No.: US 2011/0310339 A1
(43) Pub. Date: Dec. 22, 2011

(54) LIQUID CRYSTAL DISPLAY DEVICE

(76) Inventor: Masatoshi Itoh, Osaka (JP)

(21) Appl. No.: 13/202,650

(22) PCT Filed: Feb. 22, 2010
(86) PCT No.: PCT/JP2010/001149

§ 371 Date: Aug. 22, 2011

(30) Foreign Application Priority Data
Feb. 25, 2009 (JP) 2009043188

(51) Int. Cl. G02F 1/1337; H01J 9/00

(52) U.S. Cl. 349/124; 445/24

(57) ABSTRACT

A transmission-reflection combination type liquid crystal display device (100) according to the present invention includes a rear substrate (120) including an alignment film (126); a front substrate (140) including an alignment film (146); a liquid crystal layer (160) provided between the rear substrate (120) and the front substrate (140); and alignment sustaining layers (130, 150) respectively provided on the alignment films (126, 146) of the rear substrate (120) and the front substrate (140), both on the liquid crystal layer (160) side. The alignment sustaining layers (130, 150) are formed of a polymerization product obtained as a result of polymerization of a photopolymerizable compound. The liquid crystal layer (160) contains a liquid crystal compound (162) and the photopolymerizable compound (164) having a concentration of 0.045 wt. % or higher and 0.060 wt. % or less in the liquid crystal layer (160).

### TECHNICAL FIELD

The present invention relates to a liquid crystal display device, and more specifically to a transmission-reflection combination type liquid crystal display device.

### BACKGROUND ART

Liquid crystal display devices are used as, for example, small display devices such as display sections of mobile phones in addition to display sections of large-screen TVs. Liquid crystal display devices are roughly classified into reflection type liquid crystal display devices and transmission type liquid crystal display devices. Unlike self-light-emitting type display devices such as cathode ray tubes (CRTs), electroluminescence display devices and the like, transmission type liquid crystal display devices provide display using light from an illumination device (so-called backlight) located rearward to a liquid crystal panel, whereas reflection type liquid crystal display devices provide display using ambient light.

A transmission type liquid crystal display device provides display using light from the backlight and so has advantages of providing display having a high contrast ratio without being influenced by the ambient brightness, but has a problem of high power consumption due to the use of the backlight. The transmission type liquid crystal display device also has a problem of having the visibility lowered when used in a very bright environment (e.g., outdoors on a fine day). By contrast, a reflection type liquid crystal display device does not use a backlight and so has an advantage of low power consumption, but has a problem that the brightness or contrast ratio of display significantly varies in accordance with the environment of use such as the ambient brightness. Especially when used in a dark environment, the reflection type liquid crystal display device has a disadvantage of having the visibility drastically lowered.

As a liquid crystal display device capable of solving these problems, a liquid crystal display device having functions of both of a reflection type liquid crystal display device and a transmission type liquid crystal display device has been proposed. Such a transmission-reflection combination type liquid crystal display device includes a reflective region for reflecting light, and a transmissive region for transmitting light from the backlight, in one pixel area, and can switch the region to be used mainly in accordance with the environment of use (ambient brightness) or provides display using both of the regions at the same time. Therefore, the transmission-reflection combination type liquid crystal display device has both of a feature of a reflection type liquid crystal display device that the power consumption is low and a feature of a transmission type liquid crystal display device that display of a high contrast ratio can be provided without being influenced by the ambient brightness. In addition, the transmission-reflection combination type liquid crystal display device suppresses the defect of the transmission type liquid crystal display device that the visibility is lowered when used in a very bright environment (e.g., outdoors on a fine day).

TN (Twisted Nematic) mode liquid crystal display devices often used conventionally have a relatively narrow viewing angle. Recently, wide viewing angle liquid crystal display devices of an IPS (In-Plane-Switching) mode, a VA (Vertical Alignment) mode and the like have been produced. Among such wide viewing angle modes, the VA mode can realize a high contrast ratio and so is adopted for many liquid crystal display devices. Liquid crystal display devices include alignment films for regulating alignment directions of liquid crystal molecules in the vicinity thereof. In a VA mode liquid crystal display device, the alignment films align the liquid crystal molecules approximately vertically to main surfaces of the alignment films.

As one type of VA mode, an MVA (Multi-domain Vertical Alignment) mode, by which a plurality of liquid crystal domains are formed in one pixel area, is known. In an MVA mode liquid crystal display device, on at least one of a pair of substrates which face each other with a vertical alignment type liquid crystal layer interposed therebetween, an alignment anchoring structure is provided on the liquid crystal layer side. The alignment anchoring structure is formed of, for example, linear slits (openings) or ribs (projecting structures) provided in or on an electrode. Owing to the alignment anchoring structure, an alignment anchoring force is supplied from one side or both of two sides of the liquid crystal layer, and so a plurality of liquid crystal domains (typically, four liquid crystal domains) having different alignment directions are formed. In this manner, it is attempted to improve the viewing angle characteristics.

As another type of VA mode, a CPA (Continuous Pinwheel Alignment) mode is also known. In a general CPA mode liquid crystal display device, pixel electrodes having a highly symmetrical shape are provided, and also projections are provided on a counter electrode in correspondence with the centers of the liquid crystal domains. Such projections are referred to also as “rivets”. When a voltage is applied, liquid crystal molecules are radially aligned while being inclined in accordance with an oblique electric field formed by the counter electrode and the pixel electrodes of a highly symmetrical shape. By an alignment anchoring force provided by inclined side surfaces of the rivets, the inclined alignment of the liquid crystal molecules is stabilized. In this manner, the liquid crystal molecules in each pixel are aligned radially, in an attempt to improve the viewing angle characteristics.

In a general VA mode, liquid crystal molecules are aligned in a direction normal to main surfaces of the alignment films in the absence of a voltage. When a voltage is applied to the liquid crystal layer, the liquid crystal molecules are aligned in prescribed directions. Meanwhile, it has been studied to use the Polymer Sustained Alignment Technology (hereinafter, referred to as the “PSA technology”) in order to improve the response speed of a liquid crystal display device (see Patent Documents 1 through 4). According to the PSA technology, a pretilt direction of the liquid crystal molecules is controlled by polymerizing a polymerizable compound in the state where a voltage is applied to a liquid crystal layer containing a small amount of the polymerizable compound (e.g., a photopolymerizable monomer) mixed therein. As a result, the liquid crystal molecules are pretilted in the absence of a voltage such that the liquid crystal molecules are inclined with respect to the direction normal to the main surfaces of the alignment films.

Patent Document 1 describes a liquid crystal display device of an MVA mode in which slits or ribs are provided as the alignment anchoring structures. The liquid crystal display device described in Patent Document 1 includes linear slits and/or ribs. When a voltage is applied, liquid crystal molecules are aligned such that an azimuthal angle component of the liquid crystal molecules is perpendicular to the slits or ribs. When the liquid crystal molecules are irradiated with ultraviolet light in this state, a polymer is formed and the alignment state of the liquid crystal molecules is sustained (stored). Then, even after the voltage is stopped being applied, the liquid crystal molecules are still inclined at the pretilt azimuth with respect to the direction normal to the main surfaces of the alignment films.

Patent Document 2 describes a liquid crystal display device having electrodes in a pattern of tiny stripes. When a voltage is applied to the liquid crystal layer, the liquid crystal molecules are aligned parallel to a longitudinal direction of the stripes. This is of a contrast to the liquid crystal display device described in Patent Document 1, in which the liquid crystal molecules are aligned such that the azimuthal angle component thereof is perpendicular to the slits or ribs. In the liquid crystal display device described in Patent Document 2, a plurality of slits are provided, and so the disturbance of the alignment is suppressd. The liquid crystal display device is irradiated with ultraviolet light in this state to sustain (store) the alignment state of the liquid crystal molecules. Even after the voltage is stopped being applied, the liquid crystal molecules are still inclined at the pretilt azimuth with respect to the direction normal to the main surfaces of the alignment films. In this manner, the liquid crystal molecules are pretilted in the absence of a voltage, in an attempt to improve the response speed.

In the case where a large amount of photopolymerizable monomer compound remains in the liquid crystal layer, the photopolymerizable compound may be occasionally polymerized when the liquid crystal display device is driven, to cause ghosting. Patent Document 3 discloses suppressing ghosting as follows. After the polymerization step for pretilting the liquid crystal molecules, the liquid crystal layer is irradiated with ultraviolet light having a relatively low illuminance with no voltage application to the liquid crystal layer, so that the amount of the photopolymerizable compound remaining in the liquid crystal layer is decreased before the liquid crystal display device is driven.

Patent Document 4 discloses a transmission-reflection combination type liquid crystal display device. In the liquid crystal display device described in Patent Document 4, a light shielding mask is used to allow a part of the ultraviolet light to reach the liquid crystal layer, so that an alignment sustaining layer is partially formed. Thus, the retardation of the transmissive region is approximately matched to the retardation of the reflective region.

### CITATION LIST

### Patent Literature

Patent Document 1: Japanese Laid-Open Patent Publication No. 2002-357830
Patent Document 2: Japanese Laid-Open Patent Publication No. 2003-149647
Patent Document 3: Japanese Laid-Open Patent Publication No. 2003-177408
Patent Document 4: Japanese Laid-Open Patent Publication No. 2005-338472

### SUMMARY OF INVENTION

### Technical Problem

When a transmission-reflection combination type liquid crystal display device is produced using the PSA technology, stains and ht spots may be occasionally generated.

The present invention made in light of the above-described problem has an object of providing a transmission-reflection combination type liquid crystal display device in which the generation of stains and light spots is suppressed, and a method for producing the same.

### Solution to Problem

A liquid crystal display device according to the present invention is a transmission-reflection combination type liquid crystal display device and includes a rear substrate including an alignment film; a front substrate including an alignment film; a liquid crystal layer provided between the rear substrate and the front substrate; and alignment sustaining layers respectively provided on the alignment films of the rear substrate and the front substrate, both on the liquid crystal layer side. The alignment sustaining layers are formed of a polymerization product obtained as a result of polymerization of a photopolymerizable compound; and the liquid crystal layer contains a liquid crystal compound and the photopolymerizable compound having a concentration of 0.045 wt. % or higher and 0.060 wt. % or less in the liquid crystal layer.

A method for producing a liquid crystal display device according to the present invention includes the steps of preparing a transmission-reflection combination type liquid crystal cell including a rear substrate including an alignment film, a front substrate including an alignment film, and a mixture interposed between the alignment film of the rear substrate and the alignment film of the front substrate; and forming alignment sustaining layers respectively on the alignment films of the rear substrate and the front rear substrate. In the step of preparing the liquid crystal cell, the mixture contains a liquid crystal compound and a photopolymerizable compound; and in the step of forming the alignment sustaining layers, the alignment sustaining layers is formed of the photopolymerizable compound in the mixture, and after the alignment sustaining layers are formed, the photopolymerizable compound has a concentration of 0.045 wt. % or higher and 0.060 wt. % or less in the liquid crystal layer formed of the mixture.

In an embodiment, the step of preparing the liquid crystal cell, the photopolymerizable compound has a concentration of 0.25 wt. % or higher and 0.35 wt. % or less in the mixture.

In an embodiment, after the alignment sustaining layers are formed, the photopolymerizable compound has a remaining ratio of 15% or higher and 20% or less in the liquid crystal layer.

### Advantageous Effects of Invention

The present invention provides a transmission-reflection combination type liquid crystal display device in which the generation of stains and light spots is suppressed, and a method for producing the same.

### BRIEF DESCRIPTION OF DRAWINGS

FIG. 1(a) is a schematic view showing a liquid crystal display device in Embodiment 1 according to the present invention, and FIG. 1(b) is a schematic view showing a pixel electrode in the liquid crystal display device.

FIG. 2 shows an SEM image of an alignment sustaining layer of the liquid crystal display device in Embodiment 1.

FIGS. 3(a) and 3(b) are schematic views showing a method for producing the liquid crystal display device shown in Embodiment 1.

FIG. 4(a) is a schematic view of a liquid crystal display device in Comparative Example 1, FIG. 4(b) is a schematic view of a liquid crystal display device in Comparative Example 2, FIG. 4(c) is a schematic view of a liquid crystal display device in Comparative Example 3, and FIG. 4(d) is a schematic view of the liquid crystal display device in Embodiment 1.

FIGS. 5(a) through 5(e) are schematic views specifically showing the method for producing the liquid crystal display device shown in Embodiment 1.

FIG. 6 is a schematic view showing a liquid crystal display device in a modified example of Embodiment 1 according to the present invention.

FIG. 7 is a schematic view showing a liquid crystal display device in Embodiment 2 according to the present invention.

FIG. 8(a) is a schematic view showing a liquid crystal display device in Embodiment 3 according to the present invention, and FIG. 8(b) is a schematic view showing a pixel electrode in the liquid crystal display device.

FIG. 9 is a schematic view showing a liquid crystal display device in Embodiment 4 according to the present invention.

FIG. 10 is a schematic view showing a liquid crystal display device in Embodiment 5 according to the present invention.

### DESCRIPTION OF EMBODIMENTS

Hereinafter, liquid crystal display devices in embodiments according to the present invention will be described with reference to the drawings. The present invention is not limited to the following embodiments.

### Embodiment 1

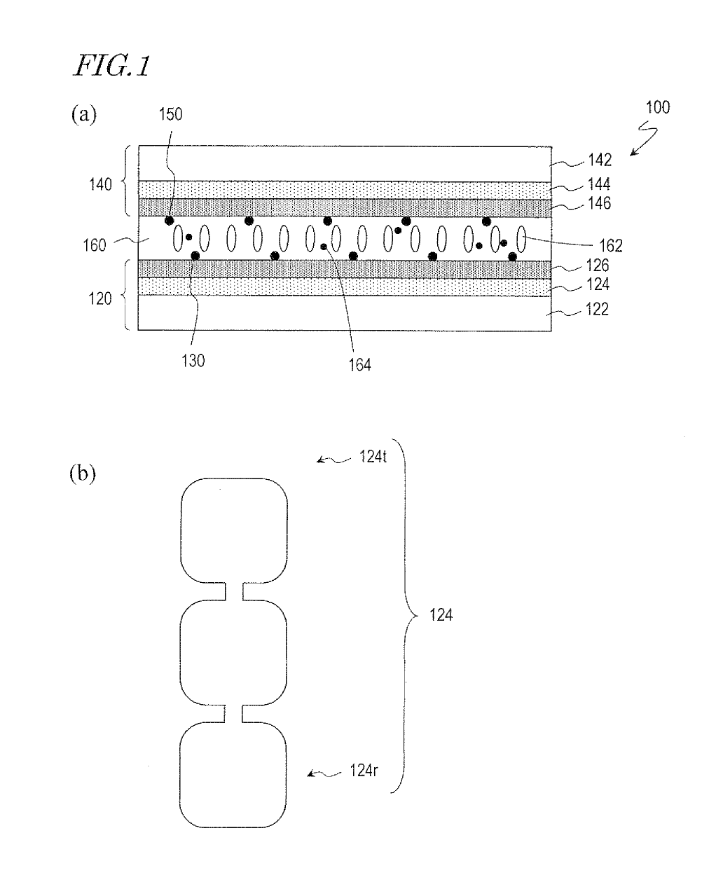

Hereinafter, liquid crystal display device in Embodiment 1 according to the present invention will be described. FIG. 1(a) shows a schematic view of a liquid crystal display device 100 in this embodiment. The liquid crystal display device 100 is of a transmission-reflection combination type.

The liquid crystal display device 100 includes a rear substrate 120, a front substrate 140, and a liquid crystal layer 160. The rear substrate 120 includes a transparent plate 122, pixel electrodes 124, and an alignment film 126. The front substrate 140 includes an insulating plate 142, a counter electrode 144, and an alignment film 146. The liquid crystal layer 160 is interposed between the rear substrate 120 and the front substrate 140. Although not shown, the liquid crystal display device 100 includes a backlight.

The liquid crystal display device 100 includes pixels arranged in a matrix having a plurality of rows and a plurality of columns. The rear substrate 120 includes switching elements (e.g., thin film transistors (TFTs); not shown). At least one such switching element is provided for each of the pixels. In this specification, the term “pixel” refers to a minimum unit which represents a particular gray scale level in display. In color display, a pixel corresponds to a unit representing, for example, the gradation of each of R, G and B, and is also referred to as a “dot”. A combination of an R pixel, a G pixel and a B pixel forms one color display pixel. The term “pixel area” refers to an area of the liquid crystal display device 100 which corresponds to the “pixel” for display. The rear substrate 120 is also referred to as the “active matrix substrate”, and the front substrate 140 is also referred to as the “counter substrate”. In the case where the liquid crystal display device 100 is a color liquid crystal display device, the front substrate 140 often includes a color filter. In such a case, the front substrate 140 is also referred to as the “color filter substrate”.

The liquid crystal display device 100 is of a transmission-reflection combination type. Each of the pixels includes a transmissive region and a reflective region. The liquid crystal display device 100 includes a reflective member (not shown in FIG. 1) on the transparent plate 122 side with respect to the liquid crystal layer 160, and this reflective member has tiny convexed and concaved portions. For example, a reflective electrode electrically connected to the pixel electrode 124, which is transparent, is provided as the reflective member in the reflective region. For example, an ITO film is used for the pixel electrode 124, and a metal reflective film such as an AI film or the like is used for the reflective member.

Although not shown, the rear substrate 120 and the front substrate 140 each include a polarizing plate. The two polarizing plates are located to face each other while having the liquid crystal layer 160 therebetween. Transmission axes (polarization axes) of the two polarizing plates are located so as to be perpendicular to each other. One is located to be along a horizontal direction (row direction), and the other is located to be along a vertical direction (column direction).

The liquid crystal layer 160 contains a nematic liquid crystal compound (liquid crystal molecules 162) having a negative dielectric anisotropy. The liquid crystal layer 160 is of a vertical alignment type, and the liquid crystal molecules 162 are aligned at approximately 90° with respect to surfaces of the alignment films 126 and 146. The liquid crystal layer 160 further contains a photopolymerizable compound 164 having a concentration of 0.045 wt. % or higher and 0.060 wt. % or less. When necessary, the liquid crystal layer 160 may contain a chiral agent incorporated therein. The liquid crystal layer 160, in combination with the polarizing plates located in crossed Nicols, provides display in a normally black mode.

As shown in FIG. 1(b), the pixel electrode 124 includes a plurality of unit electrodes, and each unit electrode has a highly symmetrical shape. When a voltage is applied to the liquid crystal layer 160, the liquid crystal molecules 162 in the liquid crystal layer 160 are aligned in an axially symmetrical state (C∞) to form liquid crystal domains. Convexed portions may be provided in the counter substrate 140 on the liquid crystal layer 160 side in correspondence with the centers of the liquid crystal domains. Such convexed portions are referred to also as the “rivets”. In this example, the pixel electrode 124 includes an electrode 124t provided in the transmissive region and an electrode 124r provided in the reflective region. The area size ratio of the electrode 124t and the electrode 124r is 7:3.

When no voltage is applied to the liquid crystal layer 160 or when the voltage applied thereto is relatively low, the liquid crystal molecules 162 are aligned generally vertically to the main surfaces of the alignment films 126 and 146. By contrast, when a prescribed level of voltage is applied to the liquid crystal layer 160, the liquid crystal molecules 162 are aligned in an axially symmetrical state while being inclined around the center of each of the unit electrodes of the electrode 124, and thus liquid crystal domains are formed. The above-described polarizing plates may be linearly polarizing plates or circularly linear polarizing plates.

In the liquid crystal display device 100 in this embodiment, an alignment sustaining layer 130 is provided on the alignment film 126 on the liquid crystal layer 160 side. The alignment sustaining layer 130 contains a polymerization product formed by polymerization of a photopolymerizable compound. An alignment sustaining layer 150 is provided on the alignment film 146 on the liquid crystal layer 160 side. The alignment sustaining layer 150 contains a polymerization product formed by polymerization of a photopolymerizable compound. For example, the alignment sustaining layer 130 is formed of the same material as the alignment sustaining layer 150. The alignment sustaining layers 130 and 150 are formed of a polymerization product of a photopolymerizable monomer. In FIG. 1(a), the liquid crystal molecules 162 are shown to be aligned parallel to the direction normal to the main surfaces of the alignment films 126 and 146, but the alignment of the liquid crystal molecules 162 is sustained in a direction slightly inclined with respect to the direction normal to the main surfaces of the alignment films 126 and 146 by the alignment sustaining layers 130 and 150. As can been seen from this, the alignment directions of the liquid crystal molecules 162 are regulated by the alignment films 126 and 146 and the alignment sustaining layers 130 and 150. The alignment sustaining layers 130 and 150 are respectively provided on the alignment films 126 and 146 in a pattern of islands, and the surface of each of the alignment films 126 and 146 may be partially in contact with the liquid crystal layer 160. Once the liquid crystal molecules 162, aligned in accordance with the electric field formed in the liquid crystal layer 160, are fixed by the polymerization product, the alignment is sustained even in the absence of a voltage. After the alignment sustaining layers 130 and 150 are formed on the alignment films 126 and 146, the alignment sustaining layers 130 and 150 regulate the pretilt directions of the liquid crystal molecules.

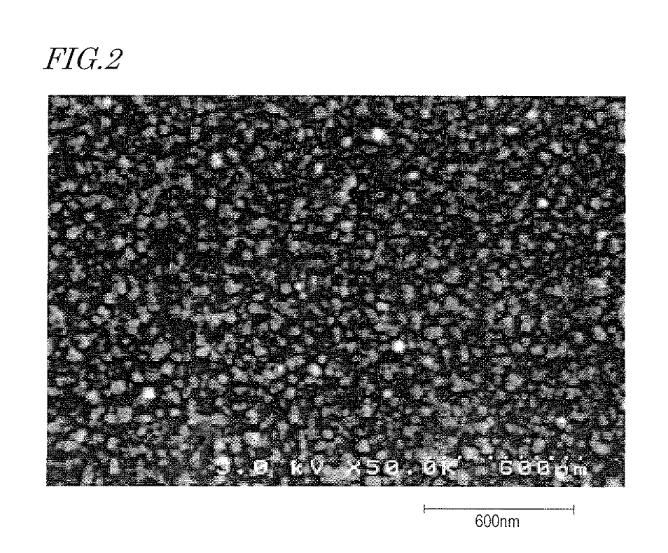

With reference to FIG. 2, an example of the above-described alignment sustaining layers 130 and 150 will be described. The SEM image shown in FIG. 2 is a result of an observation of a surface of the alignment sustaining layer. Specifically, the liquid crystal display device 100 was disassembled, the liquid crystal material was removed, and then the resultant surface was washed with a solvent and observed by an SEM. As can be seen from FIG. 2, the alignment sustaining layer contains particles of a polymerization product having a particle size of 50 nm or less. The polymerization product may occasionally grow to have a particle size of 1 μm to 5 μm.

A photopolymerizable compound is soluble in a liquid crystal compound, and a mixture of a photopolymerizable compound and a liquid crystal compound is uses as a liquid crystal material. In the case where the liquid crystal material is enclosed by the rear substrate 120, the front substrate 140 and a sealant, the alignment sustaining layers 130 and 150 are formed by polymerizing the photopolymerizable compound contained in the liquid crystal material. The liquid crystal layer 160 is formed by the mixture. The liquid crystal layer 160 also contains a part of the photopolymerizable compound 164 which has not been polymerized.

In the liquid crystal display device 100 in this embodiment; the concentration of the photopolymerizable compound to the liquid crystal material is 0.30 wt. %. A photopolymerizable compound of an amount corresponding to the concentration of 0.30 wt. % is soluble in a liquid crystal compound. The ratio of the photopolymerizable compound remaining in the liquid crystal layer 160 after the polymerization 15% or higher and 20% or less. The concentration of the photopolymerizable compound 164 remaining after the polymerization is 0.045 wt. % or higher and 0.060 wt. % or less. As described later in more detail, since the concentration of the photopolymerizable compound 164 in the liquid crystal layer 160 is appropriately set, ghosting is suppressed and also the generation of stains and light spots is suppressed.

In this example, as the photopolymerizable compound, a polymerizable monomer having at least one ring structure or condensed ring structure and two functional groups directly bonded to the ring structure or condensed ring structure is used. For example, the photopolymerizable monomer is selected from those expressed by the following general formula (1).

P¹-A¹-(Z¹-A²)ₙ-P² (1)

In general formula (1), P¹ and P² are functional groups, and are independently an acrylate, methacrylate, vinyl, vinyloxy, or epoxy group. A¹ and A² are ring structures, and independently represent a 1-4-phenylene group or a naphthalene-2,6-diyl group. Z¹ is a —COO— or —OCO— group or a single bond, and n is 0, 1 or 2.

In general formula (1), P¹ and P² are preferably an acrylate group, Z¹ is preferably a single bond, and n is preferably 0 or 1. Preferable monomers are, for example, compounds expressed by the following formulas.

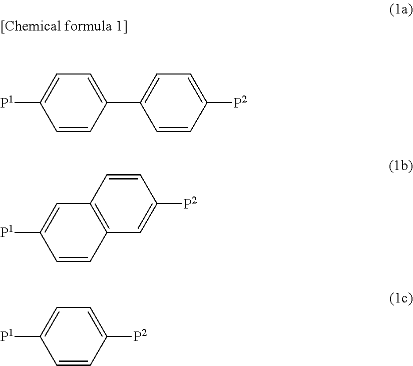

In structural formulas (1a) through (1c), P¹ and P² are as described above regarding general formula (1). Especially preferably, P¹ and P² are each an acrylate group. Among the above-identified compounds, the compounds expressed by structural formulas (1a) and (1b) are highly preferable, and the compounds expressed by structural formula (1a) are especially preferable.

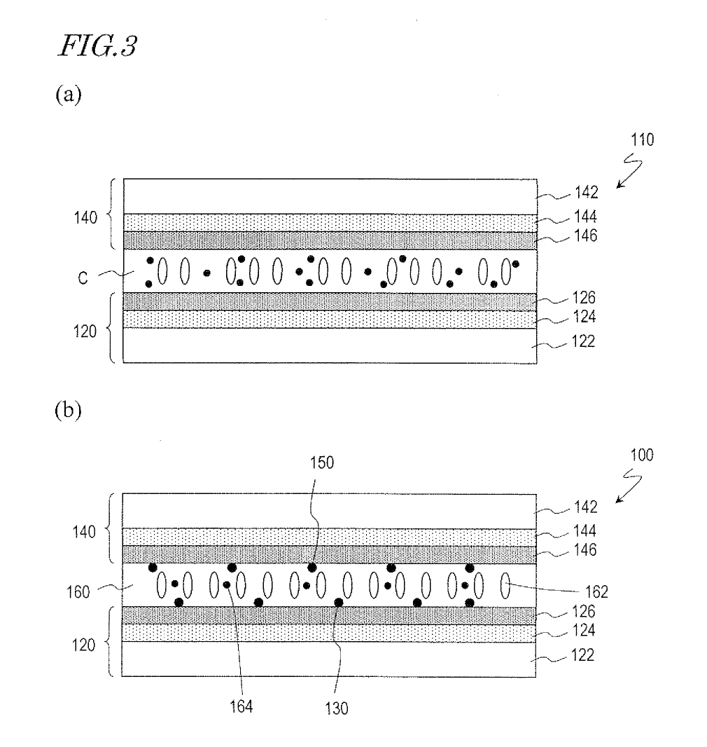

Hereinafter, with reference to FIG. 3, a method for producing the liquid crystal display device 100 will be described.

As shown in FIG. 3(a), a liquid crystal cell 110 is prepared. The liquid crystal cell 110 includes the rear substrate 120, the front substrate 140, and a mixture C interposed between the alignment film 126 of the rear substrate 120 and the alignment film 146 of the front substrate 140. The mixture C is formed of a liquid crystal material containing a liquid crystal compound and a photopolymerizable monomer mixed therein. The concentration of the photopolymerizable monomer to the liquid crystal material is 0.30 wt. %. The mixture C is sealed by a sealant (not shown in FIG. 3). The sealant may be formed of a photocurable resin or a thermosetting resin (e.g., a thermosetting acrylic-based resin), or may have properties of both of a photocurable resin and a thermosetting resin.

The liquid crystal cell 110 is produced as follows, for example. One of the rear substrate 120 and the front substrate 140 is provided with a sealant in the shape of a frame enclosing a rectangle, and a liquid crystal material is dripped to an area enclosed by the sealant. Then, the rear substrate 120 and the front substrate 140 are brought together, and the sealant is cured. Such dripping of the liquid crystal material is also referred to as “one drop filling (ODF)”. ODF makes it possible to provide the liquid crystal material uniformly, within a short time, and also at the same time to the entirety of a mother glass substrate. ODF also decreases the amount of the liquid crystal material which is disposed and so allows the liquid crystal material to be used efficiently.

Alternatively, the following process may be carried out. One of the rear substrate 120 and the front substrate 140 is provided with a sealant formed of, for example, a thermosetting resin in the shape of a frame enclosing a rectangle which has an opening, and then the rear substrate 120 and the front substrate 140 are brought together. The sealant is cured by heating to form a vacant cell. Then, the liquid crystal material is injected into a space between the rear substrate 120 and the front substrate 140. After this, the sealant may be cured in order to seal the opening.

Next, the liquid crystal cell 110 is irradiated with ultraviolet light while being supplied with a voltage to polymerize the photopolymerizable monomer in the liquid crystal material. Thus, as shown in FIG. 3(b), the alignment sustaining layer 130 is formed on the alignment film 126 of the rear substrate 120 on the liquid crystal layer 160 side, and the alignment sustaining layer 150 is formed on the alignment film 146 of the front substrate 140 on the liquid crystal layer 160 side. When a voltage is applied between the pixel electrode 124 and the counter electrode 144, the liquid crystal molecules 162 are aligned in prescribed directions. By forming the polymer in this state, the liquid crystal molecules 162 in the vicinity of the alignment films 126 and 146 are strongly regulated in this state. Therefore, even after the voltage is removed, the liquid crystal molecules 162 are kept inclined with respect to the direction normal to the main surfaces of the alignment films 126 and 146. The polymerization is performed at room temperature (e.g., 20° C.).

In the case where the front substrate 140 includes a color filter, when light is directed from the front substrate 140 side, the intensity of the light reaching the liquid crystal layer is varied depending on the wavelength changing in accordance with the color of the pixel. Therefore, in order to provide a uniform pretilt angle, it is preferable that the light is directed from the rear substrate 120 side. The liquid crystal display device 100 in this embodiment includes the transmissive region and also the reflective region. Therefore, when light is directed from the rear substrate 120 side, the intensity of light reaching the reflective region in the liquid crystal layer 160 is lower than the intensity of light reaching the transmissive region in the liquid crystal layer 160. A reason for this is: of the light directed from the rear substrate 120 side and running parallel to the direction normal to the main surface of the rear substrate 120, the light running toward the reflective region in the liquid crystal layer 160 is shielded by the reflective member. As described above, the area size ratio of the electrode 124t provided in the transmissive region of the pixel electrode 124 and the electrode 124r provided in the reflective region of the pixel electrode 124 is 7:3. The light directed from the rear substrate 120 side is also shielded by the lines of the liquid crystal display device 100. In the liquid crystal display device 100, the ratio of the open area and the shielded area is, for example, 6:4. In the following description in this specification, the ratio of the shielded area will be occasionally referred to as the “shielding ratio”.

In the case where generally parallel light is incident on the liquid crystal cell 110 from the rear substrate 120 side, the intensity of light reaching the reflective region in the liquid crystal layer 160 is lower than the intensity of light reaching the transmissive region in the liquid crystal layer 160 as described above. It is conceivable to make scattered light incident so that the intensity of light reaching the reflective region in the liquid crystal layer is generally equal to the intensity of light reaching the transmissive region. However, when scattered light is incident, the illuminance is likely to become non-uniform, and also the intensity of light reaching the liquid crystal layer is likely to become non-uniform due to the reflection or scattering at surfaces of the transparent plate and the layers/films, and at interfaces of the layers/films, in the liquid crystal cell. As a result, the pretilt angle becomes non-uniform. Alternatively, it is also possible to scatter light by providing scattering members in the liquid crystal cell so that the intensity of light reaching the reflective region in the liquid crystal layer is generally equal to the intensity of light reaching the transmissive region. In this case, however, the intensity of light becomes non-uniform due to the reduction in characteristics (e.g., reduction in the transmittance) or light scattering in the liquid crystal cell caused by the provision of the scattering members. This makes the pretilt angle non-uniform; and as a result, the display quality is reduced. For these reasons, it is difficult to make the intensity of light reaching the reflective region in the liquid crystal layer generally equal to the intensity of light reaching the transmissive region without reducing the display quality.

When a large amount of photopolymerizable monomer remains in the liquid crystal layer 160 after the liquid crystal layer 160 is irradiated with ultraviolet light while a voltage is applied between the pixel electrode 124 and the counter electrode 144, the liquid crystal layer 160 may be irradiated with ultraviolet light in the absence of a voltage between the pixel electrode 124 and the counter electrode 144 to decrease the concentration of the remaining photopolymerizable monomer. After this, driving circuits or polarizing plates are attached when necessary. In this manner, the liquid crystal display device 100 is produced.

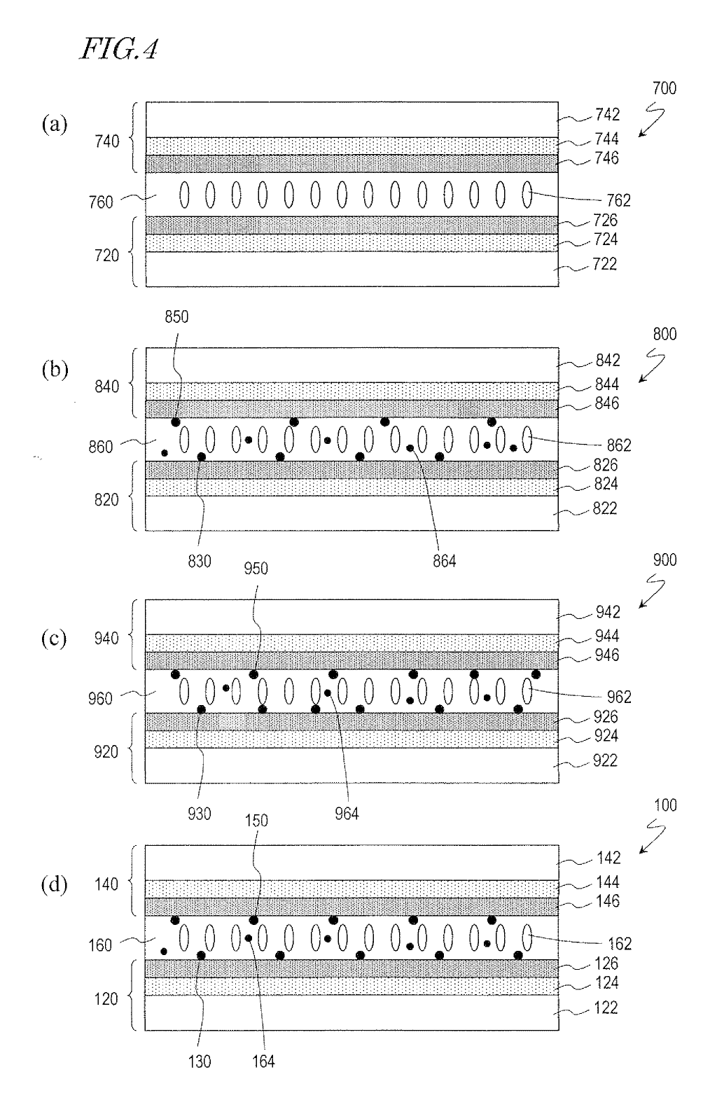

Hereinafter, with reference to FIG. 4, advantages of the liquid crystal display device 100 in this embodiment will be described as compared with liquid crystal display devices in Comparative Examples 1 through 3. FIG. 4(a) shows a schematic view of a liquid crystal display device 700 in Comparative Example 1, FIG. 4(b) shows a schematic view of a liquid crystal display device 800 in Comparative Example 2, and FIG. 4(c) shows a schematic view of a liquid crystal display device 900 in Comparative Example 3. FIG. 4(d) shows a schematic view of the liquid crystal display device 100 in this embodiment. The liquid crystal display devices 700, 800 and 900 in Comparative Examples 1 through 3 are produced in substantially the same manner as, and have substantially the same configuration as that of, the liquid crystal display device 100, except for presence/absence of a photopolymerizable monomer in the liquid crystal material and the concentration of the photopolymerizable monomer remaining in the liquid crystal layer after the polymerization.

In the liquid crystal display device 700 in Comparative Example 1, the liquid crystal layer contains no photopolymerizable monomer (hereinafter, referred to simply as the “monomer”), and so the liquid crystal display device 700 includes no alignment sustaining layer. The liquid crystal display device 800 in Comparative Example 2 uses a liquid crystal material containing a monomer at a concentration of 0.30 wt. % like the liquid crystal display device 100 and includes alignment sustaining layers 830 and 850. It should be noted that in the liquid crystal display device 800 in Comparative Example 2, the concentration of remaining monomer 864 is high. The ratio of the monomer 864 remaining after the polymerization is 30%. In the following description in this specification, the ratio of the amount of monomer remaining after the polymerization with respect to the amount of monomer originally incorporated will be referred to also as the “remaining ratio”. The remaining ratio of a monomer can be measured by gas chromatography. In the liquid crystal display device 800 in Comparative Example 2, the remaining ratio is 30%, and the concentration of the monomer 864 remaining in the liquid crystal layer 160 is 0.090 wt. % (=0.30×0.30).

The liquid crystal display device 900 in Comparative Example 3 uses a liquid crystal material containing a monomer at a concentration of 0.30 wt. % like the liquid crystal display device 100 and includes alignment sustaining layers 930 and 950. It should be noted that in the liquid crystal display device 900 in Comparative Example 3, the amount of remaining monomer 964 is sufficiently decreased. In the liquid crystal display device 900 in Comparative Example 3, the ratio of the monomer 964 remaining after the polymerization is 10%, and the concentration of the monomer 964 is 0.030 wt. %. Meanwhile, the liquid crystal display device 100 uses a liquid crystal material containing a monomer at a concentration of 0.30 wt. % and includes the alignment sustaining layers 130 and 150 as described above. In the liquid crystal display device 100 in this embodiment, the ratio of the monomer 164 remaining after the polymerization is 15% or higher and 20% or less, which is higher than that in the liquid crystal display device 900 in Comparative Example 3. The concentration of the monomer 164 in the liquid crystal layer 160 is 0.045 wt. % or higher and 0.060 wt. % or less.

Comparing the liquid crystal display device 100 in this embodiment and the liquid crystal display device 700 in Comparative Example 1, the liquid crystal display device 700 in Comparative Example 1 has a lower response speed and also a weaker alignment anchoring force. Therefore, when the surface of the panel is pressed with a finger, the alignment non-uniformity is likely to be left, and recovery requires a long time. In the liquid crystal display device 800 in Comparative Example 2, although the alignment sustaining layers 830 and 850 are formed, the concentration of the remaining monomer 864 is high and the monomer 864 is not sufficiently polymerized. Therefore, the alignment anchoring force applied to liquid crystal molecules 862 is relatively weak. For this reason, in the liquid crystal display device 800 in Comparative Example 2, when one image is displayed for a long time and then another image (e.g., an image having the same gray scale level in the entire screen) is displayed, such an image may occasionally appear to have a luminance of a gray scale level different from the gray scale level to be displayed, due to the previous image. Namely, ghosting may occur occasionally.

By contrast, in the liquid crystal display device 100 in this embodiment, the alignment sustaining layers 130 and 150 are formed as a result of sufficient polymerization of the monomer. Therefore, the response speed is improved, the destruction of alignment caused when the surface of the panel is pressed is alleviated, and also ghosting is suppressed. Also in the liquid crystal display device 900 in Comparative Example 3, the alignment sustaining layers 930 and 950 are formed as a result of sufficient polymerization the monomer like in the liquid crystal display device 100. Therefore, the response speed is improved, and ghosting is suppressed.

However, in the liquid crystal display device 900 in Comparative Example 3, stains or light spots may be occasionally generated. The liquid crystal display device 900 in Comparative Example 3 is of a transmission-reflection combination type. A polymer is formed in the reflective region in addition to the transmissive region due to diffraction or refraction of light directed through a rear substrate 920, polymerization caused by the heat generated by the light irradiation, and the flow of the liquid crystal material in a liquid crystal layer 960. In the reflective region, the monomer is not polymerized sufficiently, and so the polymer formed in the reflective region contains a dimer or a trimer. In the liquid crystal display device 900 in Comparative Example 3, the concentration of the remaining monomer is decreased by irradiating the liquid crystal layer with ultraviolet light for a long time. In accordance with this, a large amount of polymer is formed. However, in the liquid crystal display device 900 in Comparative Example 3, the intensity of light reaching the transmissive region in the liquid crystal layer 960 is high, and so the polymer in the transmissive region adheres to alignment films 926 and 946 in the transmissive region to form the alignment sustaining layers 930 and 950 on the alignment films 926 and 946 in the transmissive region. By contrast, the intensity of light reaching the reflective region in the liquid crystal layer 960 is low, and almost no light passes the interface between one of the alignment films 926 and 946 and the liquid crystal layer 960 to reach the reflective region in the liquid crystal layer 960. Therefore, the polymer is unlikely to adhere to the alignment films 926 and 946 in the reflective region, and as a result, the grown polymer floats in the liquid crystal layer 960. Such floating polymer may occasionally adhere to the alignment films 926 and 946 non-uniformly during the operation of the liquid crystal display device 900. When the floating polymer grown to have a particle diameter of 1 μm to 5 μm as a result of aggregation adheres to the alignment films 926 and 946, light spots are generated or stains appear. For example, when the aggregated polymer has a certain height, the polymer itself acts equivalently to structure bodies and thus disturbs the alignment in the vicinity thereof. As a result, light spots are generated. When the polymer, in the form of a thin layer, adheres to the alignment films or the alignment sustaining layers, the area size of the exposed portions of the alignment films is significantly decreased. As a result, the force of aligning the liquid crystal molecules vertically is decreased to change the pretilt angle, which may occasionally cause stains to appear. In this manner, stains or light spots are generated by the floating polymer.

In the liquid crystal display device 900 in Comparative Example 3, ultraviolet light irradiation needs to be performed for a long time in order to decrease the concentration of the remaining monomer. This increases the amount of the floating polymer, and lowers the reliability of the liquid crystal display device 900. The long-time ultraviolet light irradiation needs to decrease only the amount of the photopolymerizable monomer remaining after the liquid crystal molecules are pretilted, and thus is often performed in the absence of a voltage.

By contrast, in the liquid crystal display device 100 in this embodiment, the concentration of the remaining monomer 164 is relatively high, and so the amount of the polymer formed in the liquid crystal layer 160 is small. As a result, the amount of the floating polymer is small. This suppresses the generation of stains and light spots. In the liquid crystal display device 100, since the concentration of the remaining monomer 164 is relatively high, the irradiation time duration of ultraviolet light can be shorter than in the case of the liquid crystal display device 900 in Comparative Example 3. Thus, the reduction in the reliability of the liquid crystal display device 100 is suppressed. For example, the liquid crystal display device 900 in Comparative Example 3 requires 120 minutes to obtain a prescribed concentration of the remaining monomer, whereas the liquid crystal display device 900 in this embodiment requires only about 60 minutes.

As described above, the liquid crystal cell 110 may be produced using ODF. In this case, the liquid crystal display device 100 is produced as follows.

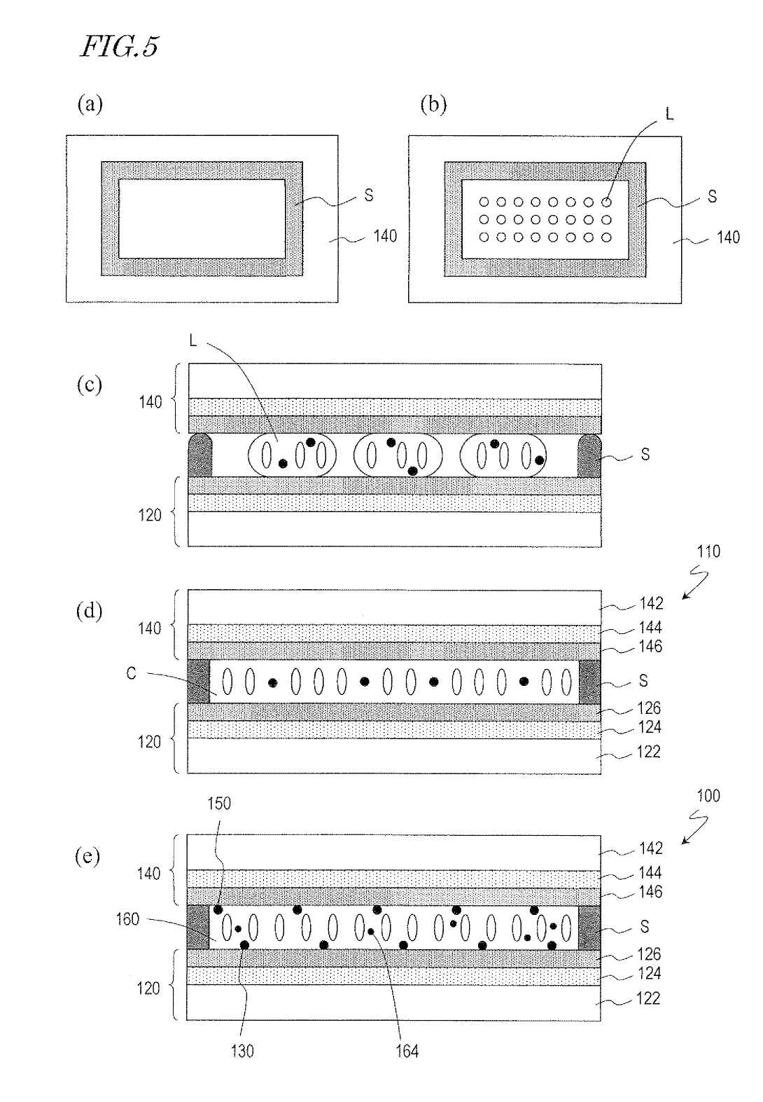

First, as shown in FIG. 5(a), for example, the front substrate 140 is provided with a sealant S for defining the liquid crystal area. The sealant S is formed of, for example, a photocurable resin or a thermosetting resin; specifically, an acrylic-based resin or an epoxy-based resin and a reactant thereto. Alternatively, the sealant S is formed of a resin having properties of a photocurable resin and a thermosetting resin and a reactant thereto.

Next, as shown in FIG. 5(b), a liquid crystal material L is dripped to the display area. The liquid crystal material L contains a liquid crystal compound and a photopolymerizable monomer mixed therein.

Next, as shown in FIG. 5(c), the rear substrate 120 is brought to the front substrate 140. The process of bringing these substrate together is performed in a vacuum atmosphere. The substrates, after being brought together, are released to the atmospheric pressure. Then, the sealant S is irradiated with light to be cured. When the sealant S is to be thermally cured, the liquid crystal cell 110 is heated to completely cure the sealant S. When necessary, the liquid crystal cell 110 is cut in order to draw terminals used to carry out the PSA technology.

Next, as shown in FIG. 5(d), a voltage is applied between the pixel electrode 124 and the counter electrode 144, and the liquid crystal cell 110 is irradiated with ultraviolet light. The voltage is applied as follows. For example, a gate voltage of 10 V is kept applied to a gate line of the liquid crystal cell 110 to maintain a TFT of a corresponding pixel in an ON state, and a data voltage of 5 V is applied to all the source lines while a rectangular wave having an amplitude of 10 V (10 V at the maximum and 0 V at the minimum) is applied to the counter electrode. As a result, an AC voltage of ±5 V is applied between the pixel electrode 124 and the counter electrode 144. As can be seen, the voltage applied between the pixel electrode 124 and the counter electrode 144 is higher than the voltage applied in order to display the highest gray scale level in normal display of the liquid crystal display device. When a voltage is to be applied to the rear substrate 120, it is preferable to set the voltage applied to the gate line to be higher than the voltage applied to the source lines (i.e., the voltage of the pixel electrode 124). This way, the alignment disturbance of the liquid crystal molecules is reduced, and so a good display quality with less coarseness can be provided. By contrast, when the gate voltage is lower than the source voltage, the pixel floats (voltage is unstable). Therefore, the alignment becomes unstable easily and the display is likely to appear to be coarse.

In the state where a voltage is thus applied, the liquid crystal cell 110 is irradiated with ultraviolet light (e.g., i-line at a wavelength of 365 nm; about 5.8 mW/cm²) for 3 to 5 minutes. As a result of this irradiation, the photopolymerizable monomer in the liquid crystal material is polymerized to form the polymer. As shown in FIG. 5(e), the alignment sustaining layers 130 and 150 are formed, and a pretilt angle of 0.1° to 5° is provided. In the case where the front substrate 140 includes a color filter layer, the intensity of the light reaching the liquid crystal layer is varied depending on the wavelength changing in accordance with the color material of each color filter layer (e.g., red, green or blue). Therefore, in order to provide a uniform pretilt angle, the liquid crystal cell 110 is generally irradiated with light directed from the rear substrate 120 side.

Next, in the state where no voltage is applied, the liquid crystal cell 110 is irradiated with, for example, ultraviolet light of about 1.4 mW/cm² for about 1 to 2 hours using black light. This decreases the concentration of the photopolymerizable monomer remaining in the liquid crystal layer. Such irradiation of light is also conducted from the rear substrate 120 side.

Owing to such irradiation of light, the photopolymerizable monomer remaining in the liquid crystal material is adsorbed to, or chemically bonded with, the alignment sustaining layers 130 and 150, and the photopolymerizable monomer molecules are polymerized. This allows the amount of the photopolymerizable monomer remaining in the liquid crystal material to be decreased. When the amount of the photopolymerizable monomer remaining in the liquid crystal layer is large, the photopolymerizable monomer molecules are polymerized slowly during the operation of the liquid crystal display device, which may undesirably cause ghosting. By performing light irradiation as described above, the occurrence of ghosting can be prevented. After this, polarizing plates or driving circuits are attached when necessary.

In the above description, the liquid crystal material is dripped to the front substrate 140. The present invention is not limited to this. The liquid crystal material may be dripped to the rear substrate 120. For irradiating the sealant with light to cure the sealant, it is preferable to direct the light from the rear substrate 120 side because a black matrix is provided in the frame area of the front substrate in general. After the liquid crystal material is dripped to the front substrate 140, the liquid crystal cell 110 is produced by bringing the rear substrate 120 to the front substrate 140, and the light source is relatively moved to a position above the liquid crystal cell 110 without inverting the liquid crystal cell 110. This way, the liquid crystal cell 110 can be irradiated with light from the light source from the rear substrate 120 side. By dripping the liquid crystal material to the front substrate 140 in this manner, the liquid crystal panel can be produced by a simple process.

Alternatively, the voltage may be applied as follows while the liquid crystal cell 110 is irradiated with ultraviolet light. A gate voltage of 15 V is kept applied to all the gate lines in the display area of the liquid crystal cell 110 to maintain a TFT provided in each pixel in an ON state, and a data voltage of 0 V is applied to all the source lines while a rectangular wave having an amplitude of 10 V (5 V at the maximum and −5 V at the minimum) is applied to the counter electrode. As a result, an AC voltage of ±5 V is applied to the liquid Crystal layer.

The alignment anchoring force or the pretilt angle can be controlled in accordance with the level of the voltage applied to the liquid crystal layer and also the irradiation time duration of the ultraviolet light. By increasing the voltage applied to the counter electrode step by step, the disturbance of the alignment state in each pixel may be occasionally reduced to provide a good display quality with less coarseness.

As the light source, a low pressure mercury lamp (sterilizing lamp, fluorescent chemical lamp, black light), a high pressure discharge lamp (high pressure mercury lamp, metal halide lamp), a short arc discharge lamp (super-high pressure mercury lamp, xenon lamp, mercury xenon lamp) or the like may be used. Light from the light source may be directed as it is, or light of a particular wavelength (or of a particular wavelength region) selected by a filter may be directed.

FIG. 1 shows the transmissive region and the reflective region in the liquid crystal layer 160 as having an equal thickness to each other, but the present invention is not limited to this. In the transmissive region, light which has been incident from the rear substrate side and has passed the liquid crystal layer contributes to display. By contrast, in the reflective region, light which has been incident from the front substrate side, has passed the liquid crystal layer, has been reflected by the reflective member and has passed the liquid crystal layer again contributes to display. Therefore, where the transmissive region and the reflective region in the liquid crystal layer 160 have an equal thickness to each other and further the refractive index anisotropy per unit thickness of the liquid crystal layer in the transmissive region is equal that in the reflective region, the retardation of the reflective region is twice the retardation of the transmissive region.

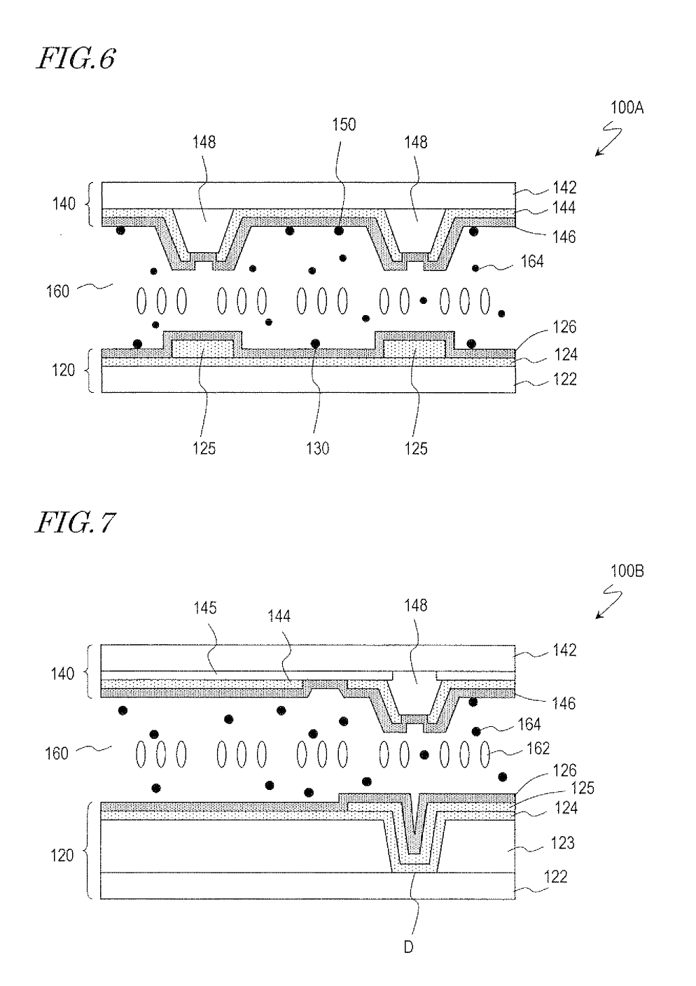

In a liquid crystal display device 100A shown in FIG. 6, a transparent dielectric layer 148 is provided between the transparent plate 142 and the counter electrode 144 of the front substrate 140 in the reflective region. In this case, the thickness of the reflective region in the liquid crystal layer 160 is approximately half of the thickness of the transmissive region, and so the retardation of the reflective region can be approximately matched to the retardation of the transmissive region.

Hereinafter, with reference to Table 1, characteristics of liquid crystal panels having different remaining ratios of the monomer will be described. Table 1 shows the measurement results on the stains, light spots and ghosting and the measurement results in a thermal test and an impact test, when the remaining ratio is varied to 4%, 10%, 15%, 20%, 30% and 40%. The concentration of the monomer incorporated into the liquid crystal material is 0.30 wt. %. The ratio of the open area and the shielded area of the liquid crystal panel is 60:40. The shielded area includes the areas of the reflective members and also the areas corresponding to the lines. The thickness of the transmissive region in the liquid crystal layer is 4 μm, and the thickness of the reflective region is 2 μm.

TABLE 1

| Remaining ratio | 4% | 10% | 15% | 20% | 30% | 40% |
|---|---|---|---|---|---|---|
| Stains | Generated | Generated | Not generated | Not generated | Not generated | Not generated |
| Light spots | Generated | Generated | Not generated | Not generated | Not generated | Not generated |
| Ghosting | Not generated | Not generated | Not generated | Not generated | Generated | Generated |
| Thermal test | Not changed | Not changed | Not changed | Not changed | Changed | Changed |
| Impact test | Not changed | Not changed | Not changed | Not changed | Changed | Changed |

Regarding the stains and the light spots, the display of the liquid crystal panel is checked in the state where a voltage is applied to the liquid crystal layer. There is a general tendency that when the remaining ratio of the monomer is lower, the amount of the polymer present in the liquid crystal layer is larger. When the amount of the polymer is too large, the amount of the floating polymer is too large. As a result, stains and light spots are generated in the display of the liquid crystal panel.

In this example, presence/absence of the stains and the light spots is checked as follows. The liquid crystal panel is operated at a high temperature of 70° C. and at room temperature, and the display of the liquid crystal panel is checked visually and by a microscope. When the remaining ratio of the monomer is 10% or less, the amount of the floating polymer is too large. As a result, stains and light spots are generated in the display of the liquid crystal panel. By contrast, when the remaining ratio of the monomer is 15% or higher, the generation of stains and light spots is suppressed.

Regarding ghosting, the display of the liquid crystal panel is checked after an image is displayed for a long time. Generally, in the case where no polymer is formed, when one image (pattern) is displayed for a long time and then another image is displayed, the previous image (pattern) appears to remain. This is called “ghosting”. Ghosting is suppressed by forming a polymer through polymerization of a photopolymerizable monomer. However, when the remaining ratio of the monomer is high and so the amount of the polymer formed is small, ghosting may occur occasionally.

Presence/absence of ghosting is checked as follows. First, a pattern in which the central part of the display area is black and the peripheral part of the display area is white is displayed for a long time. Specifically, this pattern is displayed continuously, for example, in a high temperature tank of 70° C. for 240 hours. The backlight of the liquid crystal display device is kept turned on. Then, a prescribed intermediate level is displayed in the entire display area. At this point, when it is found visually and by a luminance evaluation that the luminance of the peripheral part in which white has been displayed is different from the luminance of the central part in which black has been displayed, it is determined that ghosting has occurred. When the remaining ratio is 30% or higher, ghosting occurs; whereas when the remaining ratio is 20% or less, the occurrence of ghosting is suppressed.

Regarding the thermal test, the display of the liquid crystal panel is checked after an image is displayed for a long time while the liquid crystal panel is heated. In general, even when a polymer is formed and the alignment of the liquid crystal molecules is regulated temporarily, if the liquid crystal layer is supplied with a voltage while being heated, a part of the polymer is detached from the alignment films to partially decrease the regulating force of the polymer. Thus, the tilt angle of the liquid crystal molecules is changed, and the alignment directions of the liquid crystal molecules are returned to the alignment direction before the polymer formation, i.e., the vertical alignment direction. As a result, the display of the liquid crystal panel may be occasionally changed. When the remaining ratio is high and the amount of the polymer formed is small, the display is likely to be non-uniform. From such results of the thermal test, the adhesiveness of the polymer is found. Generally, the pretilt angle of the liquid crystal molecules may occasionally become zero by aging. Accordingly, the results of the thermal test also provide a barometer of aging.

The thermal test is performed as follows. It is checked whether or not the display of the liquid crystal panel is changed visually and by a luminance non-uniformly evaluation in a high temperature tank of 80° C. When the remaining ratio is 30% or higher, the display of the liquid crystal panel is changed; whereas when the remaining ratio is 20% or less, the change of the display of the liquid crystal panel is suppressed.

In the impact test, it is checked whether or not the display of the liquid crystal panel is changed after an impact is given to the liquid crystal panel. When the adhesiveness of the polymer to the interfaces is low because of the amount of the polymer formed and the growth speed of the polymer, the start point of the polymer which tilts the liquid crystal molecules is lost by the impact. In this case, the anchoring force of the polymer is partially decreased, and the pretilt angle of the liquid crystal molecules is changed. Thus, the alignment directions of the liquid crystal molecules are returned to the alignment direction before the polymer formation, i.e., the vertical alignment direction. As a result, the display of the liquid crystal panel may be occasionally changed. From such results of the impact test, the adhesiveness of the polymer is found, like the thermal test described above.

The impact test is performed as follows. The liquid crystal panel is vibrated or an impact is given to a main surface of the liquid crystal panel at a high temperature (e.g., 70° C.) and at room temperature, while the liquid crystal panel is operated. Then, the change of the display of the liquid crystal panel is checked visually and by a luminance difference evaluation. When the remaining ratio is 30% or higher, the display of the liquid crystal panel is changed; whereas when the remaining ratio is 20% or less, the change of the display of the liquid crystal panel is suppressed.

As described above, in the liquid crystal display devices 100 and 100A, by setting the remaining ratio of the monomer to 15% or higher and 20% or less, ghosting and the change of the display, and also the generation of stains and light spots, can be suppressed.

In the case where, as shown in FIG. 1(b), the pixel electrode 124 includes a plurality of unit electrodes and the liquid crystal display device is of a CPA mode, the alignment of the liquid crystal molecules can be further stabilized by incorporating a chiral agent into the liquid crystal material.

In the above description, the ratio of the open area and the shielded area in the liquid crystal panel is 60:40. Preferably, the ratio of the open area and the shielded area in the liquid crystal panel is in the range of 80:20 to 30:70. The shielded area includes the areas of the reflective members and also the areas corresponding to the lines. In this case, by setting the remaining ratio to 15% or higher and 20% or less, the generation of stains and light spots can be suppressed.

Hereinafter, with reference to Table 2, characteristics of liquid crystal panels having different shielding ratios will be described. Table 2 shows the measurement results on the display quality, when the shielding ratio is varied to 15%, 20%, 30%, 40%, 50%, 70% and 75%. The concentration of the monomer incorporated into the liquid crystal material is 0.25 wt. %, 0.30 wt. % and 0.35 wt. %.

TABLE 2

| Shielding ratio | | 15% | 20% | 30% | 40% | 50% | 70% | 75% |
|---|---|---|---|---|---|---|---|---|
| Monomer | 0.25 wt. % | ⊚ | ◯ | ◯ | ◯ | ◯ | ◯ | X |
| concentration | 0.30 wt. % | ⊚ | ◯ | ◯ | ◯ | ◯ | ◯ | X |
| | 0.35 wt. % | ⊚ | ◯ | ◯ | ◯ | ◯ | ◯ | X |

In Table 2, “◯” indicates that the display quality is not reduced when the concentration of the monomer remaining in the liquid crystal layer is 0.045 wt. % or higher and 0.060 wt. % or less. “⊚” indicates that the display quality is not reduced even when the concentration of the monomer remaining in the liquid crystal layer is 0.045 wt. % or less.

As can be understood from Table 2, the display quality is not reduced over a relatively wide range of the shielding ratio of 20% or higher and 70% or less. In the polymerization step, ultraviolet light is directed basically in parallel, but as described above, a small amount of ultraviolet light enters the reflective region in the liquid crystal layer because the monomer flows in the liquid crystal layer while the liquid crystal layer is irradiated with the ultraviolet light and also because the directed light is diffracted, refracted, reflected or scattered by the film interfaces or the structure bodies in the liquid crystal cell. This is considered to be the reason whey a generally similar effect is obtained over a relatively wide range of the shielding ratio of 20% or higher and 70% or less.

In the case where the shielding ratio is 75%, when the monomer concentration to the liquid crystal material is 0.25 wt. %, stains are generated; and when the monomer concentration to the liquid crystal material is 30 wt. % or higher, stains and also light spots are generated. It is understood from this that when the shielding ratio is relatively high, stains and also light spots are generated because as the monomer concentration to the liquid crystal material is higher, a larger floating polymer is likely to be formed.

### Embodiment 2

With reference to FIG. 7, a liquid crystal display device in Embodiment 2 according to the present invention will be described. A liquid crystal display device 100B in this embodiment includes a rear substrate 120, a front substrate 140, and a liquid crystal layer 160. The rear substrate 120 includes a transparent plate 122, pixel electrodes 124, an alignment film 126, and a flattening film 123 provided between the transparent plate 122 and the pixel electrodes 124. The liquid crystal display device 100B has substantially the same configuration as that of the liquid crystal display device 100A described above, except that the liquid crystal display device 100B includes the flattening layer 123. The descriptions of the identical elements to those of the liquid crystal display device 100A will be omitted to avoid redundancy.

In the liquid crystal display device 100B, the pixel electrodes 124 are provided on the flattening layer 123, and each pixel electrode 124 can be formed at a position overlapping the lines (not shown). The flattening layer 123 has contact holes formed therein, and the pixel electrode 124 and a drain electrode D of the TFT are electrically connected to each other through such a contact hole.

The flattening layer 123 is formed of an acrylic-based or imide-based insulating material. Especially in the case where an organic material is used for the flattening layer 123, the flattening layer 123 is partially decomposed by being irradiated with ultraviolet light to generate gas. As a result, air bobbles may be occasionally generated in the liquid crystal layer 160. When the air bobbles are generated in the liquid crystal layer 160, the alignment of the liquid crystal molecules 162 is disturbed in the area in which the air bobbles are generated and the luminance is decreased (such an area is also referred to as the “black spot”). Thus, the display quality is reduced.

In the liquid crystal display device 100B, a transparent dielectric layer 148 is provided in the front substrate 140 in the reflective region. Owing to the transparent dielectric layer 148, the thickness of the reflective region in the liquid crystal layer 160 is approximately half of the thickness of the transmissive region. In this manner, by providing the transparent dielectric layer 148, the retardation of the reflective region in the liquid crystal layer 160 can be made substantially the same as the retardation of the transmissive region.

In the liquid crystal display device 100B in this embodiment, the liquid crystal material contains a photopolymerizable monomer at a concentration of 0.30 wt. %. The concentration of the photopolymerizable monomer 164 in the liquid crystal layer 160 is 0.045 wt. % or higher and 0.060 wt. % or less. The remaining ratio of the photopolymerizable monomer is 15% or higher and 20% or less. In the liquid crystal display device 100B in this embodiment, the concentration of the photopolymerizable monomer 164, which is 0.045 wt. % or higher and 0.060 wt. % or less, is relatively high. The remaining ratio of the photopolymerizable monomer, which is 15% or higher and 20% or less, is also relatively high. Therefore, the irradiation time duration of ultraviolet light can be shortened. Therefore, the generation of air bubbles can be suppressed.

Hereinafter, with reference to Table 3, characteristics of liquid crystal panels having different remaining ratios of the monomer will be described. Table 3 shows the measurement results on the stains, light spots, air bubbles and ghosting and the measurement results in a thermal test and an impact test, when the remaining ratio of the monomer is varied to 4%, 10%, 15%, 20%, 30% and 40%. Here again, the concentration of the monomer incorporated into the liquid crystal material is 0.30 wt. %.

TABLE 3

| Remaining ratio | 4% | 10% | 15% | 20% | 30% | 40% |
|---|---|---|---|---|---|---|
| Stains | Generated | Generated | Not generated | Not generated | Not generated | Not generated |
| Light spots | Generated | Generated | Not generated | Not generated | Not generated | Not generated |
| Air bubbles | Air bubbles | Air bubbles | Air bubbles | Air bubbles | Air bubbles | Air bubbles |
| | generated | not generated | not generated | not generated | not generated | not generated |
| Ghosting | Not generated | Not generated | Not generated | Not generated | Generated | Generated |
| Thermal test | Not changed | Not changed | Not changed | Not changed | Changed | Changed |
| Impact test | Not changed | Not changed | Not changed | Not changed | Changed | Changed |

When the remaining ratio is 4%, air bubbles may be occasionally generated in the liquid crystal layer 160 because the irradiation time duration of ultraviolet light is relatively long. By contrast, when the remaining ratio is 10% or higher, the reduction in the display quality caused by the generation of the air bubbles can be suppressed because the irradiation time duration of ultraviolet light is relatively short. The results regarding the stains, light spots, ghosting, the thermal test and the impact test are as described above with reference to Table 1.

### Embodiment 3

Regarding the pixel electrode in the liquid crystal display device shown in FIG. 1(b), the electrode provided in the transmissive region and the electrode provided in the reflective region are formed of substantially the same unit electrode as each other. The present invention is not limited to this. The electrode provided in the transmissive region may have a different shape from that of the electrode provided in the reflective region.

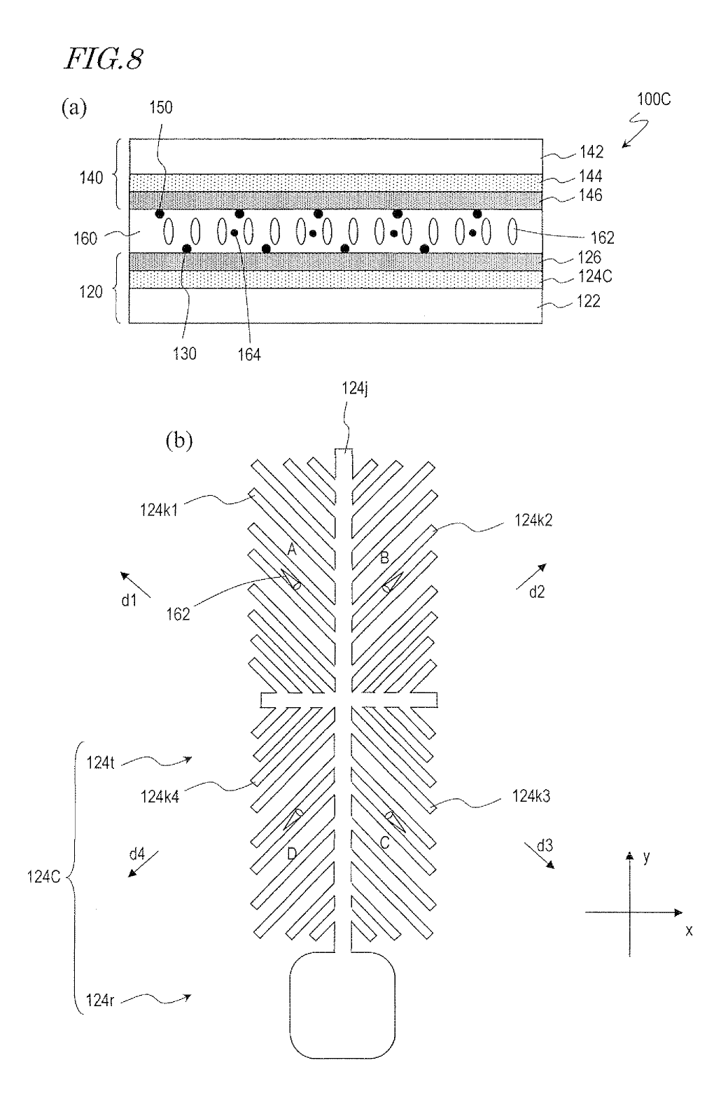

With reference to FIG. 8, a liquid crystal display device in Embodiment 3 according to the present invention will be described. FIG. 8(a) shows a schematic view of a liquid crystal display device 100C in this embodiment. The liquid crystal display device 100C in this embodiment has substantially the same configuration as that of the liquid crystal display device 100 described above, except for the shape of pixel electrodes 124C. The descriptions of the identical elements to those of the liquid crystal display device 100 will be omitted to avoid redundancy.

As shown in FIG. 8(b), in the liquid crystal display device 100C, the pixel electrodes 124C each include an electrode 124t provided in the transmissive region and an electrode 124r provided in the reflective region. The electrode 124t includes a cruciform trunk electrode 124j and linear electrodes 124k1 through 124k4 extending from the trunk electrode 124j in four different directions d1 through d4. Such a structure of the pixel electrode is referred to as a “fishbone structure”. The trunk electrode 124j extends in x and y directions. For example, in the pixel electrode 124t, the trunk electrode 124j has a width of 3 μm. The linear electrodes 124k1, 124k2, 124k3 and 124k4 each have a width of 3 μm and are located at an interval of 3 μm. Assuming that the horizontal direction (left-right direction) of the display screen (the plane of the sheet of FIG. 8(b)) is the reference on which the direction of azimuthal angle is set and the counterclockwise direction is the positive direction (assuming that the display screen is the face of a clock, the direction of 3 o'clock is 0° in azimuthal angle and the counterclockwise direction is the positive direction), the directions d1 through d4 are directed at 135°, 45°, 315° and 225°, respectively. The electrode 124r is a highly symmetrical unit electrode and is electrically connected to the trunk electrode 124j of the electrode 124.

When a voltage is applied to the liquid crystal layer 160 of the liquid crystal display device 100C, the liquid crystal molecules 162 in the transmissive region are aligned parallel to the directions in which the corresponding linear electrodes 124k1 through 124k4 extend as shown in FIG. 8(b). The liquid crystal layer 160 is of a vertical alignment type, and includes a liquid crystal domain A formed by the linear electrodes 124k1, a liquid crystal domain B formed by the linear electrodes 124k2, a liquid crystal domain C formed by the linear electrodes 124k3, and a liquid crystal domain D formed by the linear electrodes 124k4. When no voltage is applied to the liquid crystal layer 160 or when the voltage applied thereto is relatively low, the liquid crystal molecules 162 are aligned vertically to main surfaces of the alignment films (not shown) except for the liquid crystal molecules 162 in the vicinity of the pixel electrode 124. By contrast, when a prescribed level of voltage is applied to the liquid crystal layer 160, the liquid crystal molecules 162 are aligned in the directions d1 through d4 in which the linear electrodes 124k1, 124k2, 124k3 and 124k4 extend.

In this specification, the alignment direction of the liquid crystal molecules at the center of each of the liquid crystal domains A through D is referred to as the “reference alignment direction”. Of the reference alignment direction, an azimuth angle component of a direction from the rear side to the front side along the longer axis of the liquid crystal molecules (namely, the azimuth angle component of the liquid crystal molecules projected on the main surfaces of the alignment films) is referred to as the “reference alignment azimuth”. The reference alignment azimuth characterizes a corresponding liquid crystal domain and dominantly influences the viewing angle characteristics of the respective liquid crystal domain. Where the horizontal direction (left-right direction) of the display screen (the plane of the sheet of FIG. 8(b)) is the reference direction on which the direction of azimuth angle is set and the counterclockwise direction is the positive direction, the reference alignment azimuths of the four liquid crystal domains A through D are set such that the difference between two random azimuths out of these four azimuths is generally equal to an integral multiple of 90°. Specifically, the reference alignment azimuths of the liquid crystal domains A, B, C and D are 315°, 225°, 135° and 45°, respectively. In this manner, the liquid crystal molecules 162 are aligned in four different directions, and owing to this, the viewing angle characteristics are improved.

When a voltage is applied to the liquid crystal layer 160, the liquid crystal molecules 162 in the reflective region are aligned in an axially symmetrical state while being inclined around the unit electrode of the pixel electrode 124, and thus a liquid crystal domain is formed. A convexed portion may be provided in the counter substrate 140 on the liquid crystal layer 160 side in correspondence with the center of the electrode 124r.

In the liquid crystal display device 100C shown in FIG. 8, the electrode 124t provided in the transmissive region has a fishbone structure; whereas the electrode 124r provided in the reflective region is formed of a unit electrode. The present invention is not limited to this. The electrode provided in the transmissive region and the electrode provided in the reflective region may each have a fishbone structure.

### Embodiment 4

In the liquid crystal display device 100B described above with reference to FIG. 7, the flattening film is provided in the rear substrate, but the present invention is not limited to this. The flattening film may be provided in the front substrate.

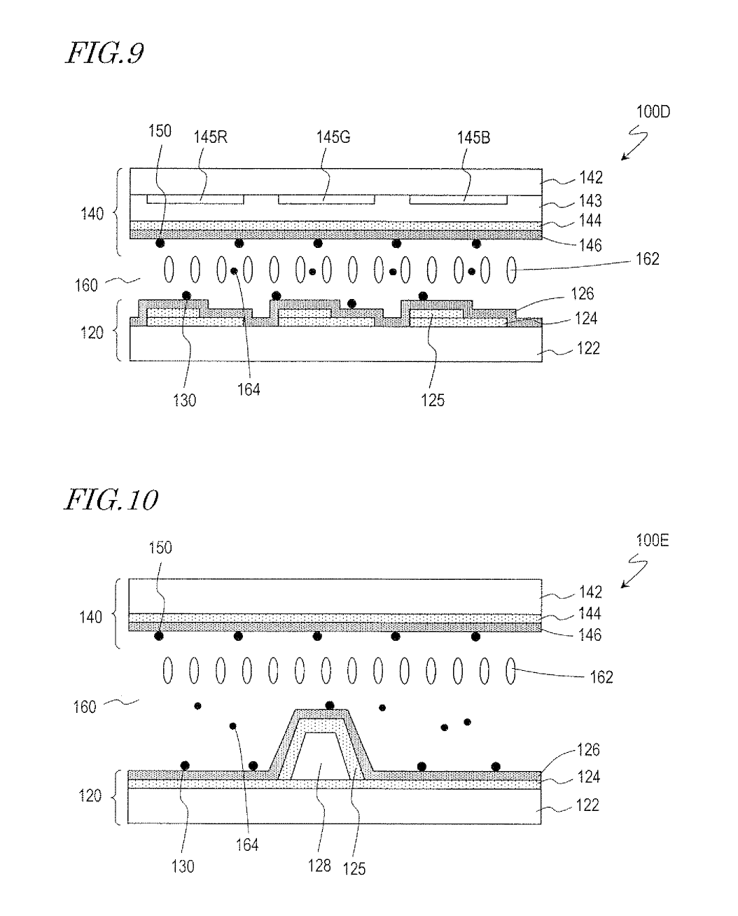

Hereinafter, with reference to FIG. 9, a liquid crystal display device in Embodiment 4 according to the present invention will be described. A liquid crystal display device 100D in this embodiment has substantially the same configuration as that of the liquid crystal display device 100B described above, except that the front substrate 140 in the liquid crystal display device 100D further includes a flattening film 143. The descriptions of the identical elements to those of the liquid crystal display device 100B will be omitted to avoid redundancy.

The flattening film 143 covers color filter layers 145R, 145G and 145B, and the counter electrode 144 is provided on a surface of the flattening film 143. The flattening film 143 is formed of an acrylic-based or imide-based resin.

Owing to the flattening film 143, even when the color filter layers 145R, 145G and 145B partially overlap each other at the border between the pixels, the reduction in the contrast due to the alignment disturbance can be suppressed. A transparent dielectric layer may be provided on the flattening film 143 in the reflective region, or resin spacers for keeping the cell thickness may be provided on the flattening film 143.

### Embodiment 5

In the liquid crystal display device 100A shown in FIG. 6, the transparent dielectric layer 148 is provided in the front substrate 140, but the present invention is not limited to this. The transparent dielectric layer may be provided in the rear substrate.

Hereinafter, with reference to FIG. 10, a liquid crystal display device in Embodiment 5 according to the present invention will be described. A liquid crystal display device 100E in this embodiment has substantially the same configuration as that of the liquid crystal display device 100 described above, except that the rear substrate 120 in the liquid crystal display device 100E includes a transparent dielectric film 128. The descriptions of the identical elements to those of the liquid crystal display device 100A will be omitted to avoid redundancy.

The transparent dielectric film 128 is provided on the pixel electrode 124 in the reflective region. In the liquid crystal display device 100E, the transparent dielectric film 128 is covered with a reflective electrode 125 having tiny convexed and concaved portions.

The liquid crystal panel may be of any other ECB mode. The liquid crystal panel may be of a TN mode.

The disclosure of Japanese Patent Application Nos. 2009-43188, upon which the present application claims the benefit of priority, is incorporated herein by reference.

### INDUSTRIAL APPLICABILITY

According to the present invention, a liquid crystal display device in which the generation of stains and light spots is suppressed can be provided.

### REFERENCE SIGNS LIST

100 Liquid crystal display device
120 Rear substrate
122 Transparent plate
124 Pixel electrode
126 Alignment film
140 Front substrate
142 Transparent plate
144 Counter electrode
146 Alignment film

1. A transmission-reflection combination type liquid crystal display device, comprising:
a rear substrate including an alignment film;
a front substrate including an alignment film;
a liquid crystal layer provided between the rear substrate and the front substrate; and
alignment sustaining layers respectively provided on the alignment films of the rear substrate and the front substrate, both on the liquid crystal layer side;
wherein:
the alignment sustaining layers are formed of a polymerization product obtained as a result of polymerization of a photopolymerizable compound; and
the liquid crystal layer contains a liquid crystal compound and the photopolymerizable compound having a concentration of 0.045 wt. % or higher and 0.060 wt. % or less in the liquid crystal layer.

2. A method for producing a liquid crystal display device, comprising the steps of:
preparing a transmission-reflection combination type liquid crystal cell including a rear substrate including an alignment film, a front substrate including an alignment film, and a mixture interposed between the alignment film of the rear substrate and the alignment film of the front substrate; and
forming alignment sustaining layers respectively on the alignment films of the rear substrate and the front rear substrate;
wherein:
in the step of preparing the liquid crystal cell, the mixture contains a liquid crystal compound and a photopolymerizable compound; and
in the step of forming the alignment sustaining layers, the alignment sustaining layers is formed of the photopolymerizable compound in the mixture, and after the alignment sustaining layers are formed, the photopolymerizable compound has a concentration of 0.045 wt. % or higher and 0.060 wt. % or less in the liquid crystal layer formed of the mixture.

3. The method for producing a liquid crystal display device of claim 2, wherein in the step of preparing the liquid crystal cell, the photopolymerizable compound has a concentration of 0.25 wt. % or higher and 0.35 wt. % or less in the mixture.

4. The method for producing a liquid crystal display device of claim 2, wherein after the alignment sustaining layers are formed, the photopolymerizable compound has a remaining ratio of 15% or higher and 20% or less in the liquid crystal layer.
